(19) United States
(12) Patent Application Publication
(10) Pub. No.: US 2020/0040237 A1
(43) Pub. Date: Feb. 6, 2020

(54) ADHESIVE FILM THAT CAN BE WOUND AND STAMPED

(71) Applicant: Lohmann GmbH & Co. KG, Neuwied (DE)

(72) Inventors: Patrik KOPF, Neuwied (DE); Oliver KUEHL, Strassenhaus (DE)

(73) Assignee: Lohmann GmbH & Co. KG, Neuwied (DE)

(21) Appl. No.: 16/488,138

(22) PCT Filed: Feb. 22, 2018
(86) PCT No.: PCT/EP2018/054383

§ 371 Date: Aug. 22, 2019

(30) Foreign Application Priority Data
Feb. 22, 2017 (DE) 10 2017 001 696.8

(51) Int. Cl. C09J 163/00; C09J 7/38; C09J 11/08

(52) U.S. Cl. CPC C09J 163/00; C09J 7/38; C08K 5/36; C09J 2205/31; C09J 11/08

(57) ABSTRACT

The invention relates to an adhesive film that can be wound and stamped, having an epoxy-based adhesive compound that can be activated by UV radiation, characterized in that the adhesive compound comprises: a) 2-40 wt % of film former, b) 10-70 wt % of aromatic epoxy resins, c) cycloaliphatic epoxy resins, the cycloaliphatic epoxy resins not exceeding 35 wt %, d) 0.5-7 wt % of cationic initiators, e) 0-50 wt % of epoxy-enhanced polyether compounds, and f) 0-20 wt % of polyol, the proportions adding up to 100%, and the adhesive compound having an open time of 10 seconds to 60 minutes after the UV activation, during which open time the film has a pressure-sensitive adhesive characteristic.

### CROSS REFERENCE TO RELATED APPLICATIONS

The present application is a United States national phase patent application of International Patent Application PCT/EP2018/054383 filed on Feb. 22, 2018, which claims foreign priority to German Patent Application No. 10 2017 001 696.8 filed on Feb. 22 2017, the entirety of each of which is incorporated by reference hereby.

### TECHNICAL FIELD

The present invention relates to an adhesive film that can be activated and cured by ultraviolet radiation (UV) for structural bonding, which is pressure-sensitive adhesive in character in its non-activated state.

The terminology used in the descriptions below is to be understood as follows:

“Adhesive film” hereinafter relates to any type of spatial adhesive systems, i.e. not only adhesive tapes in the stricter sense of the word but also adhesive films, adhesive strips, adhesive plates or adhesive stamped parts.

“Pressure-sensitive adhesive” refers to adhesive bonds where the two join partners are bonded together by way of an intermediary adhesive layer and subject to pressure. The bond is reversible in that it can be released again without damaging the two join partners because the adhesive seam is the weakest link in the adhesive bond.

“Structural” adhesive bonds are such bonds where the join partners are bonded in such a manner that in the event that they are separated the bond is not necessarily released at the adhesive seam but under certain circumstances also one of the join partners may constitute the weakest link in the bond and is then damaged by the separation. Hence, structural adhesive bonds possess high strength levels. Strength levels, measured by way of a quasi-static tensile shear test, are in excess of 6 MPa for structural bonds. Typical values aspired to for structural adhesive bonds of epoxy adhesives are between 10 to 20 MPa.

“Radiation/irradiation curing” refers to a process where using high-energy rays reactive materials are conveyed from a low-molecular to a high-molecular state.

In the case in hand UV radiation is understood to be UVA (ultraviolet A) or UVC (ultraviolet C) light. UVA radiation is in a wavelength range of ca. 380 to 315 nanometres (nm), UVC radiation is in a wavelength range of ca. 280 to 100 nm. Generally, both constitute electromagnetic radiation at wavelengths that are shorter than visible light. For UVA light the energy input is ca. 3.26 to 3.95 electron volt (eV), for UVC light the energy input is ca. 4.43 to 12.40 eV.

“Activation” means that the adhesive starts curing after being exposed to UV radiation, i.e. the photo initiators included in the adhesive are activated by light irradiation and trigger the curing process by initiating the formation of polymer chains. Customarily, UV curing adhesives are exposed to radiation after the join partners have been joined. For this, substrates are required that are sufficiently permeable for the UV radiation used. The adhesion seam is irradiated for as long until the curing has progressed sufficiently. At first of all is disadvantageous that impermeable substrates cannot be glued together that way and secondly that the radiation times are relatively long.

“Open time” is the time between the application of the adhesive and the adhesion process. During open time, for example, a liquid melt adhesive will spread on the surfaces to be bonded and provide for the requisite adhesion. Given that the viscosity of an adhesive generally increases after application, for adhesives the open time is subject to time restraints.

“Curing time” is the period between the joining of the join partners and the final strength of the bond.

“Dark reaction” consequently means the fact that a curing reaction is triggered by short-term irradiation of the adhesive with UV light, effecting complete curing without additional irradiation.

### DISCUSSION OF RELATED ART

Often, the basis of UV curing adhesives consists in acrylate monomers or oligomers that cure in a UV induced radical chain reaction.

UV curing epoxy adhesives in turn are cured by a cationic photo initiator. In cationic UV curing, a ring opening occurs at the oxirane and/or oxetane (epoxy resins and vinyl ether). This is achieved by way of photolysis e.g. of diaryliodononium salts, which effects the generation of strong proton acids. The acid proton opens the epoxy ring and sets off chain growth and thus curing.

In contrast to radical UV curing of acrylates, this results in reduced shrinking and good adhesion to a large number of substrates. Insensitivity towards oxygen is another advantage of cationic curing, allowing for high curing speeds under regular air conditions. Humidity and alkali, in turn, tend to be of more influence than in radical UV curing.

In cationic initiation it may under certain circumstance be possible to delay chain formation to such an extent that it ultimately occurs in the dark without further exposure to radiation. It may potentially also be substantially delayed so that it is only reactivated re-accelerated by heat treatment. Trigger radiation, i.e. a brief kick-start by radiation, is sufficient for curing to start. Further curing then occurs in the subsequent dark reaction away from the UV light. It may even be possible that a certain “open time” is created, i.e. first the open adhesive layer is irradiated and time remains to perform the joining with the second substrate without suffering reduction of the bonding properties. This approach would then allow for bonding substrates that are not UV transparent.

One model assumes that curing first takes place at the surface of the adhesive compound and then gradually progresses. The acid is capable of diffusing through the still liquid layer so that also areas can be cured that are not directly irradiated.

The yield or wavelength range of cationic photo initiator such as for example iodonium salts can also be enhanced by sensitisers such as for example thioxanthone derivatives.

Epoxies comprise a chemical group of compounds of highly reactive cyclic organic compounds. They include a triple ring where in comparison to cyclopropane a carbon atom is substituted by an oxygen atom. Epoxy groups thus form the simplest hetero-cycles including oxygen. The oxygen bridge is referred to as epoxy bridge.

In industrial contexts in general, requirements for adhesive bonds are ever increasing, for example in terms of breaking strength, temperature resilience, resilience to changing climates, humidity and heat resilience, etc. This is due to the fact that adhesive tapes are used increasingly in automotive manufacturing, e.g. for weight reasons or also because thus it is not necessarily required to create point-shaped bonds but even distribution of the bonding strength is achieved across an adhesive seam, and last but not least also because the joining partners are not damaged as it is the case with certain other joining processes such as for example in the case of screwed links or riveting.

Pressure-sensitive adhesive tape is not capable of fulfilling such requirements.

However, often such requirements can be fulfilled by structural adhesive tapes. Frequently, these structural adhesive tapes are cured in a thermal process after joining. However, if the adhesive or the adhesive tape, respectively, must not require be thermally curing because the substrates to be joined only tolerate very little thermal input that is not sufficient for curing, an adhesive or an adhesive tape must be used, respectively, that is cured using a different curing mechanism.

The hot-curing epoxy adhesive tapes known in the art have limited shelf life. Despite curing temperatures in excess of 120° C., also at room temperature the adhesive tapes deteriorate when stored for an extended period of time. Therefore, they have to be kept refrigerated or even frozen. The storage problem is even exacerbated when curing systems are used that can be activated at lower curing temperatures as low as room temperature.

Under these circumstances, the shelf life of the adhesive tapes would be even worse, thus additionally limiting the scope of use for industrial storage and process times for such adhesive tapes.

It would therefore be of great benefit if a UV curing adhesive tape were provided that is storage-stable at room temperature, preferably curing only subject to UV light, i.e. without any major additional thermal input and that exhibits an open time during curing that allows for joining after UV irradiation, whereas the curing results in a structural adhesive bond.

UV light-activated, cationically initiated epoxy adhesives are already known in the literature. WO 2015/198921 A1 for example describes a photo-curing compound for optical transparent systems comprised of an epoxy with an alicyclical epoxy group without ester compound, an oxetane compound, a photo-cationic polymerisation initiator including an anion comprising a phosphor or boron as well as an inorganic filling substrate. This adhesive is used in the joining of optical elements. For example, the adhesive is applied to a first level of an optical system, then a second layer is applied to the adhesive layer and the compound is then irradiated with UV LED light so that the adhesive is cured and adhesion is effected. Such a compound may consist in more than two layers including adhesive provided between two layers, each. WO 2102173055 A1 and JP 05498870 B2 describe optical films produced in a similar manner for example for LCDs. There is no mention of an open time or joining of non-transparent substrates.

JP 2015057467 claims a two-layer compound including at least one plastic layer, which is produced by applying an adhesive including a cationic photo initiator to a plastic layer, applying a second layer to the adhesive layer and curing the adhesive by radiation from the side. Radiation from the side circumvents the problem of transparency of the substrates, but can only be implemented for smaller surfaces.

Further applications for cationically initiated epoxy systems in the form of transparent coatings of labels, varnishes of cans or other containers are the subject matter for example of CN 102708755 A and JP 2009185219 A. A curable compound formed by mixing an epoxy resin and a thermoplastic ethylene vinyl acetate co-polymer resin with an organo-metallic cation for the curable epoxy resin is the subject matter of WO 1999/057216 A1. DE 198 57 237 A1 describes the manufacture of film compounds by way of an adhesive including at least three components, where one component comprises at least one compound including at least one epoxy group and another component including at least one cationic photo-initiator, which initiates polymerisation of the at least two remaining components after irradiation with light.

EP 0 819 746 B1 and EP 1 249 479 B1 claim an adhesive comprised of an acrylate polymer, a photo-polymerising compound including an epoxy group and a cationic photo polymerisation initiator. The acrylate polymer provides the compound with initial cohesion strength and is sufficiently tacky to easily adhere to a join partner. After adhesion, the adhesive is irradiated with light, thus activating the polymerisation initiator and effecting ring opening polymerisation of the photo-polymerising compound including at least one epoxy group. Here, irradiation takes place after the joining.

A number of property rights describe light-induced, dark curing liquid adhesives, in part with delayed curing, such as for example WO 2006/029059 A1 or US 2005/0256230 A1, other documents such as US 2003/0176585 A1 or U.S. Pat. No. 7,053,133 B2 claim a film that is cured without being delayed, e.g. by way of an inhibitor. Thermally conductive epoxy tape including a thermally conductive filling substrate is the subject matter of WO 2014/047932 A1. However, no structural strength is achieved here. WO 2014/093414 A1 claims an adhesive epoxy film exhibiting initial curing of 50% only, the final curing is effected by heat application. To this end, temperatures in excess of 100° C. are required.

The prior art has nothing to offer regarding an epoxy resin based adhesive formulation where apart from the cationic photo initiator no further initiator is required as a radical starter for activation. Also, the prior art has nothing to offer regarding an adhesive film including or comprising such adhesive that is already slightly pressure-sensitive adhesive in its non-activated state, where the adhesive requires no heat for curing, is activated by UV light irradiation only, and that cures after a delay without an additional corresponding inhibitor, generating structural adhesive strength.

### DETAILED DISCLOSURE

Based on the prior art, it is an object of the present invention to provide an enhanced adhesive film that can be wound and stamped.

This object is solved by a device exhibiting the features of claim 1. Advantageous embodiments derive from the dependent claims.

Accordingly, an adhesive film is provided that can be wound and stamped including an epoxy-based adhesive compound that can be activated by UV radiation. According to the invention, the adhesive compound comprises:
g) 2-40 wt % of film former,
h) 10-70 wt % of aromatic epoxy resins,
i) cyclo-aliphatic epoxy resins, the cyclo-aliphatic epoxy resins not exceeding 35 wt %,
j) 0.5-7 wt % of cationic initiators,
k) 0-50 wt % of epoxy-enhanced polyether compounds, and
l) 0-20 wt % of polyol,
   the proportions adding up to 100%, and the adhesive compound having an open time of 10 seconds to 60 minutes after the UV activation, during which open time the film has a pressure-sensitive adhesive characteristic.

Surprisingly, it was found that based on the composition according to the invention, an adhesive film (adhesive tape) can be produced the curing of which is triggered by irradiating the exposed adhesive film, which can be joined after an open time of 10 seconds to 60 minutes and that ultimately results in structural adhesive strength. Moreover, the adhesive film is stable under regular conditions. This means that production and handling is possible under ambient light conditions without additional UV protection. Moreover protected against UV light the adhesive film can be stored for months at room temperature.

In a preferred embodiment, the shelf life of the non-cured adhesive film at room temperature is at least 6 months without negatively affecting the functional properties of the adhesive film.

A film former constitutes a substantial component of the adhesive film. It allows for the generation of a film that can be wound and stamped. Film formers are thermoplastic or elastomer polymer compounds that regulate viscosity so that after coating and, if applicable, drying, a film is generated that can be wound and stamped. For example, the following polymers can be used as film formers: Acrylates, polyamides, phenoxy resins, polyurethanes or ethylene vinyl acetates (EVAs), whereas preferable polyurethanes and ethylene vinyl acetate copolymers are used.

Aromatic, aliphatic and cyclo-aliphatic epoxy resins are used as epoxy resins. In terms of viscosity, they can be liquid, highly viscous or solid. Preferably, measured by the share of the epoxy equivalent of the mixture, the share of aromatic resins is higher than the share of cyclo-aliphatic epoxy resins. In a preferred embodiment, the share of the epoxy equivalent of the cyclo-aliphatic epoxy resins in the epoxy equivalent of all epoxy resins is between 0% and 35%.

In a further preferred embodiment, the share of the epoxy equivalent of the aromatic epoxy resins in the epoxy equivalent of all epoxy resins is more than 60%. This allows for open times of 10 seconds to 60 minutes.

Moreover, the adhesive film includes at least one polyether compound that has been derivatised with epoxy groups. Preferably, these are epoxy-enhanced polyethylene glycols or poly-propylene glycols. In a preferred embodiment, the share of the epoxy equivalent of the epoxy-enhanced epoxy resins in the epoxy equivalent of all epoxy resins is between 0% and 40%. By adjusting the share of the polyether compounds, it is possible to effectively adjust the open time.

Compounds with several free hydroxy groups (polyols) are another component of the adhesive film, such as for example poly-ethylene glycols, poly-tetrahydrofurane or poly-propylene glycols. According to the literature, adding polyols is responsible for delaying the curing reaction (A. Hartwig, “Kationisch hartende Epoxidharzklebstoffe”, February 2012). According to that document, transmission reactions cause an extension of the curing reaction, resulting in a dark reaction. Together with the epoxy-enhanced polyethers, polyols are consequently useful for controlling the open time and the speed of the cross-linking reaction.

Cationic photo-initiators are used as initiators for the adhesive film. Suitable initiators are, for example: arylsulfonium, iodonium, ferrocenium or thioxathenium salts, especially preferably triarylsulfonium salts. They are characterised by a fast decomposition reaction already at relatively low UV irradiation. When the initiators decompose, acids are formed that cure epoxy resins.

As further components for the adhesive film, the following additives for epoxy adhesive tapes known to the skilled person are available: shock resistance modifiers, organic or inorganic fillers, also functional fillers such as flame protection substances, dyes, antioxidants, levelling and rheology additives.

The finished adhesive film can be provided as a single-layer film (referred to as transfer adhesive tape), it may consist of a backing (e.g. made of film paper or textile) coated with the adhesive compound on one side, or a backing coated on two sides, or two different layers of adhesive compound layers on top of one another.

Moreover, the invention comprises the combination of the present adhesive films with other adhesive layers such as for example pressure-sensitive adhesive or melt-adhesive layers, again with or without a backing.

Typically, also covers (release liners) are a component of adhesive tapes and adhesive films, respectively. Here, as a general rule, all ubiquitously known types of release liners can be used.

The processing and coating of the adhesive compound can be effected using a solvent or hotmelt process. Also the so-called syrup technology can be used for processing and coating, where the film-forming component is only produced from monomers or oligomers during the coating process.

The adhesive film is pressure-sensitive adhesive in its non-activated state and can thus be handled just like any “regular” pressure-sensitive adhesive tape, i.e. it can be applied offering mild adhesion and, if necessary, may also be repositioned. Stamped parts can be formed out of the adhesive film that can be pre-applied on the respective parts to be glued together.

Curing of the pre-applied adhesive films and stamping parts is finally activated using UV light, preferable UVA or UVC light. Only then, the join partners are finally and structurally joined. Given that the curing reaction takes place in several steps, also after activation a certain period remains during which the parts to be joined can be finally adjusted and joined, additional activation by UV light is no longer necessary after the curing has been triggered.

The duration of the dark reaction strongly depends on different factors such as for example the epoxy resin component used (cyclo-aliphatic or aromatic epoxy resin), the chain length, the initiator type, the irradiation time, the radiation dosage (UV wavelength or also the temperature. The curing time after irradiation can amount to between 10 seconds and 60 minutes depending on the aforementioned factors and their interplay.

In a preferred embodiment, the adhesive film that can be wound and stamped is suitable in particular for the structural bonding of metals, glass, ceramics, glass fibre plastics (GFP), carbon fibre plastics (CFP) and other high-energy surfaces.

In a further preferred embodiment, the adhesive film that can be wound and stamped has adhesion strength rates between 6 and 20 MPA depending on the formulation details, radiation dosage and substrates to be glued together.

### BRIEF DESCRIPTION OF THE FIGURES

FIG. 1 shows the curing curve for two different formulations.

### DETAILED DESCRIPTION OF THE EMBODIMENTS

### 2. Materials Used

| Identification | Type | Reference |
|---|---|---|
| Desmomelt 530 | film former, polyester polyurethane | Covestro |
| Levamelt 900 | film former, ethyl vinyl acetate | Lanxess |
| Levamelt 456 | film former, ethyl vinyl acetate | Lanxess |
| Phenoxy Resin PKHM-301 | film former, phenoxy resin | Gabrielchem |
| Araldite GT 7072 N | aromatic epoxy resin, solid, | Huntsman |
| | melting point 89° C., | |
| | epoxy equivalent 570-585 g/eq | |
| D.E.R 331 | aromatic epoxy resin, liquid resin, | Olin |
| | highly viscous, epoxy equivalent 182-192 g/eq | |
| Uvacure 1534 | cyclo-aliphatic epoxy resin, | Allnex |
| | epoxy equivalent 190-210 g/eq | |
| D.E.R. 736 P | epoxy-enhanced polyether | Olin |
| | compound | |
| | (propylenglycol-epichlorhydrine- | |
| | copolymer), | |
| | epoxy equivalent 150-205 g/eq | |
| Araldite DY 3601 | epoxy-enhanced polyether | Huntsman |
| | compound | |
| | (polypropylene glycoldiglycidyl- | |
| | ether, epoxy equivalent 385-405 g/eq | |
| Heloxy Modifier WF | epoxy-enhanced polyether | Hexion |
| | compound | |
| | (butylene glycol diglycidyl ether, | |
| | epoxy equivalent 380-420 g/eq | |
| PEG 400 | polyethylene glycol | BASF |
| Chivacure 1176 | cationic UV initiator, based on | Chitec |
| | triarylsulfonium salt | |
| Chivacure 1190 | Cationic UV initiator, based on | Chitec |
| | triarylsulfonium salt | |
| Omicat 432 | Cationic UV initiator, based on | IMG resins |
| | triarylsulfonium salt | |
| Omicat 550 BL | Cationic UV initiator, based on | IMG resins |
| | thioxhanthenium | |
| UV 387 C | Cationic UV initiator, based on | Deuteron |
| | iodonium salt | |
| Chivacure 2-ITX | UV sensitiser for increasing light | Chitec |
| | yield | |

### 2. Manufacture of the Adhesive Films and their UV Activation

All percentage statements relate to weight percent.

Preparation of the Adhesive Film:

Adhesive Compound:

The film former is pre-dissolved in a suitable solvent mixture, if applicable subject to slight heating of the mixture. Then the remaining components are dissolved separately in a suitable solvent mixture (epoxy resins, epoxy-enhanced polyether compound, polyol and LTV initiator). Finally, the two solutions are mixed together while stirring. The solvents or solvent mixtures are selected from among the solvents known to the skilled person such that the components are easy to solve or disperse, or result in a suitable mixture exhibiting viscous properties such that the mixture can be coated upon a film or a backing. The ratio of the solvent mixture in relation to the remaining components is selected such that coatable viscosity is obtained and that the adhesive compound including solvents is sufficiently stable between its production and the coating process. For the sample formulations, the following solvents are used: Film former: Desmomelt 530 and phenoxy resin PKHM-301: methyl ethyl ketone, Levamelt types: ethyl acetate, remaining components: Ethyl acetate. The solids content of the finished adhesive compound solutions is 50-70%.

Coating:

The adhesive compound containing solvents is applied to silicon-enhanced polyester film (thickness: 50 μm). Then it first is dried at room temperature for 10 minutes and then at 80° C. in a convection oven for 10 minutes. The amount to be applied is adjusted such that after drying (removal of the solvent mixture) a layer thickness of 50 μm is obtained.

A pressure-sensitive adhesive (tacky) film is obtained of a thickness of ca. 50 μm.

No protective measures against UV light are necessary during handling of the raw materials, the adhesive and for the coating. It is sufficient to work under regular laboratory conditions away from the UV lamp. No further shielding is required.

UV Irradiation of the Pressure-Sensitive Adhesive Film:

The pressure-sensitive adhesive film is glued on to the first substrate (plate made of glass fibre-reinforced plastics GFRP, length: 25 mm, width. 25 mm, thickness: 2 mm) at a size of ca. 312 mm² (width: 25 mm, length: 12.5 mm). Finally the silicon-enhanced polyester film is removed. This substrate is then irradiated with UV light (either UVC light from a discharging lamp or UVA light from a UVA-LED source). After irradiation, during the open time and outside of the irradiation zone, the second substrate is pressed onto the open adhesive film (the adhesive film is still pressure-sensitive adhesive also after the irradiation) so that the two substrates overlap and the adhesive surface amounts to 25 mm×12.5 mm. The two substrates are fixed with braces and stored at room temperature. Tensile shear strength is then measured for that sample after 24 hours, unless specified otherwise.

UV irradiation, unless specified otherwise, is effected using a UV lab device by Beltron with a conveyor belt and a UVC radiator with a radiation maximum at 256 nm. The conveyor belt is operated at 2 m/min. The radiation dosage in the UVC range, measured using a UV Power Puck II by EIT Intstrument Market Group, amounts to 197 mJ/cm².

Tests with a UVA lamp are performed using the LED Spot 100 by Honle. It consists in a UV LED (wavelength 365 nm) and a radiation chamber. The samples are irradiated for 15 seconds in the radiation chamber. The radiation dosage, measured using a UV Power Puck II by EIT Intstrument Market Group, amounts to 5000 mJ/cm².

Note:

Despite the substantially higher wavelength, the adhesive compounds can also be activated using the UV LED device. Similar radiation times as in the UVC device are feasible and the results regarding open time and adhesive strength are in the same range. Presumably, the significantly higher intensity of the UVA radiation compensates for the smaller energy quantums so that the photo initiators are capable of starting the curing reaction. For example, the intense UVA radiation could have its effect as a consequence of a “prohibited” transition of the photo initiator.

Open Time:

Open time is considered the maximum feasible duration between the removal from the radiation belt (UVC) or removal from the radiation chamber (UVA), respectively, and the point in time when the joining with the second substrate takes place. During this period, the join parts can be joined. It is defined such that the adhesive layer is still pressure-sensitive adhesive (tacky). The open time is determined by finger-checking the tack of the surface of the adhesive films after irradiation. Directly after irradiation, the adhesive film is still tacky. After a certain time, the degree of conceivable tack decreases and reduces further until eventually the surface is non-tacky. The open time is determined as the point in time when tack decreases conceivably. It turns out that as long as the surfaces are still tacky, joining is possible and the subsequent curing results in a homogeneous adhesive bond. As soon as the surfaces lose tack, the curing process has progressed so much already that no joining is possible any longer. This is reflected in the significantly reduced strength values determined based on the quasi-static tensile shear strength. Joining of the adhesive films takes place at the end of the open time.

Time Until Handling Strength:

This means the period that elapses after the joining step until the strength of the bond is so hard that glued parts can already be transported and processed further. Here, we presume that handling strength has been reached once the quasi-static tensile shear strength has reached two Megapascal. This is a degree of strength that will tolerate the loads exerted during an industrial manufacturing process.

Curing Time:

The curing time is the period between the joining and the final strength of the bond. All sample formulations are fully cured after a maximum of 24 hours. Therefore, for the most part the waiting time was 24 hours before testing for the quasi-static tensile shear strength. When a value in excess of 6 MPa is achieved, structural strength or structural bonding is considered to have been obtained.

For the use case, sufficient open time is desired. Swift achievement of handling strength is advantageous in case the bond has to withstand a first load soon after joining (e.g. during transport of the parts) or in order to forego fixing the parts, respectively. For full curing, in turn, 24 hours are sufficient because according to experience only after that amount of time the bond tolerates the final load (permanent load or shock loads).

Open time and curing time are consequences of the reaction speed of the curing reaction. This reaction starts with UV activation and ends upon full curing of the adhesive film. Curing is complete once the final strength of the adhesive bond has been achieved. During the open time and curing time, different phases exhibiting different reaction speeds may pass, delays and accelerations may occur, resulting in a certain overall open time and curing time. The open time and curing time can be controlled by adjusting the formulation, the radiation type and intensity and duration as well as thermal management (temperatures) during the gluing process.

### 3. Test Methods

a) Quasi-Static Tensile Shear Test

After curing, the samples are subjected to a quasi-static tensile shear test. The samples are produced and cured as described above (substrate: GFRP). After a resting time of 24 h until full curing has been achieved, the samples are suspended in a tensile shear testing device and torn apart at room temperature and at a speed of 2 mm/min. The maximum force of the force path curve in relation to the adhesion surface (312 mm²) is specified as the tensile shear value in N/mm² or MPa. The values identified are the mean value of 3 measurements.

b) Determination of the Open Time

The pressure-sensitive adhesive film is glued onto the first substrate (plate made of glass fibre-reinforced plastic GFRP, length: 25 mm, width. 25 mm, thickness: 2 mm) in a size of ca. 312 mm² (width: 25 mm, depth: 12.5 mm). Finally, the silicon-enhanced polyester film is removed. This substrate is then irradiated with UV light. Directly after irradiation, the timer is started. The substrate is stored at room temperature in the lab away from the UV light area. In reasonable intervals, the film is finger-checked for tack. Initially it is still tacky, but after a certain time, tack decreases conceivably until it dissipates entirely. The finger-check is always performed on a fresh part of the adhesive film. As soon as tack diminishes, the timer is stopped. The open time is then defined as the period of time where no loss in tack can yet be perceived. It is determined as a mean value from three individual samples.

For the joining for measuring bond strength, additional samples of the same type are irradiated and then joined before the end of the previously determined open time.

c) Determination of the Time Until Handling Strength

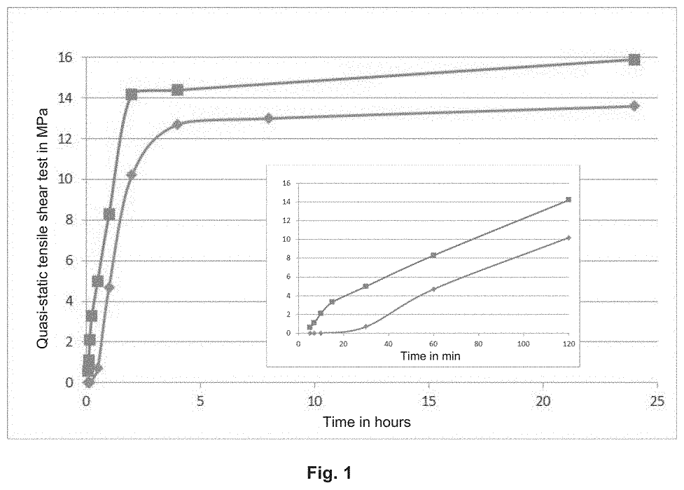

For determining the time until handling strength, adhesive strength is monitored for several samples during the curing process. Depending on the curing speed, adhesion strength is built up swiftly or slowly. Based on measuring the quasi-static tensile shear strength, a handling time is determined as the time that elapses until a value of 2 MPa has been reached. FIG. 1 shows the curing curve for two different formulations, whereas the one formulation cures fast (upper curve) and the other cures slowly (bottom curve). For the formulations, the time until handling strength is less than triple the open time.

d) Calculating the share of a group of epoxy resins in the epoxy equivalent.

The epoxy equivalent EPₜₒₜ of a formulation is calculated based on the epoxy equivalents EPᵢ of the individual epoxy resins and their respective weight share aᵢ in the formulation according to the following formula:

EPtot=Σᵢ₌₁ⁿ(aᵢ×EPᵢ) with n=number of epoxy resins and Σᵢ₌₁ⁿ(a₁)=1

The share of the cyclo-aliphatic resins (cyc) in the epoxy equivalent is calculated as follows:

A_{cyc}×a_{cyc}×EP_{cyc}/EPₜₒₜ

Accordingly, the share of aromatic (arom) epoxy resins is calculated as follows:

Aₐᵣₒₘ=aₐᵣₒₘ×EPₐᵣₒₘ/EPₜₒₜ

Accordingly, the share of epoxy-enhanced epoxy resins is calculated as follows:

Aₑₜₕₑᵣ=aₑₜₕₑᵣ×EPₑₜₕₑᵣ/EPₜₒₜ

### 4. Examples

Hereinafter, the sample and comparative sample formulations are outlined. Only the “fixed” weight ratios of the adhesive compounds are provided in percent, without taking into account the solvents. The manufacture and coating by way of a suitable solvent are performed as described above and known to the skilled person. Similarly, the manufacture and coating could be performed without solvents as a so-called hotmelt. Glas fibre reinforced plastic (GFRP) is used as the substrate used, as described above. Radiation is performed using a UVC lamp.

a) Share of Cyclo-Aliphatic Epoxy Resin

Uvacure 1534 is used as an example of cyclo-aliphatic epoxy resin. Desmomelt 530 is used as a film former, Araldite GT 7072 and D.E.R. 331 are the aromatic epoxy resins used. Moreover, the formulations include the epoxy-enhanced polyether compound D.E.R. 736P and the polyol PEG 400. The Chivacure 1176 is used as UV initiator.

Examples B1 through B7 show different contents of cyclo-aliphatic epoxy resin.

The epoxy equivalent EPₜₒₜ is calculated using the above formula and in a mean value amounts to 200 g/eq. The share of the cyclo-aliphatic epoxy resin (here: Uvacure 1534) A_{cyc} is then calculated based on the above formula. The share of the aromatic epoxy resin Aₐᵣₒₘ is calculated accordingly via the share of the aromatic resins Araldite GT 7072 and D.E.R. 331. The same applies to the share of epoxy-enhanced polyether compound (here: D.E.R. 736 P) Aₑₜₕₑᵣ.

TABLE 1
Formulations B1 to B7

| | B1 | B2 | B3 | B4 | B5 | B6 | B7 |
|---|---|---|---|---|---|---|---|
| Desmomelt 530 | 11% | 11% | 11% | 11% | 11% | 11% | 11% |
| Araldite GT 7072 | 38% | 38% | 38% | 38% | 38% | 38% | 38% |
| D.E.R. 736 P | 12% | 12% | 12% | 12% | 12% | 12% | 12% |
| D.E.R. 331 | 30% | 25% | 20% | 15% | 10% | 0% | 0% |
| Uvacure 1534 | 0% | 5.0% | 10% | 15% | 20% | 30% | 40% |
| PEG 400 | 7.0% | 7.0% | 7.0% | 7.0% | 7.0% | 7.0% | 7.0% |
| Chivacure 1176 | 2.0% | 2.0% | 2.0% | 2.0% | 2.0% | 2.0% | 2.0% |
| Epoxy equivalent | 371 | 372 | 373 | 374 | 375 | 377 | 357 |
| in g/eq | | | | | | | |
| Aₐᵣₒₘ | 93% | 90% | 86% | 83% | 80% | 73% | 69% |
| A_{cyc} | 0% | 3% | 7% | 10% | 13% | 20% | 25% |
| Aₑₜₕₑᵣ | 7% | 7% | 7% | 7% | 7% | 7% | 6% |

The share of the cyclo-aliphatic epoxy resin A_{cyc} amounts from 0 to 25%. Accordingly, the share of the aromatic epoxy resin Aₐᵣₒₘ is calculated as 93% to 69%. The share of the epoxy-enhanced polyether compound Aₑₜₕₑᵣ is 7%.

TABLE 2
Measurement results B1 to B7

| | B1 | | B2 | | B3 | | B4 | | B5 | | B6 | | B7 | |
|---|---|---|---|---|---|---|---|---|---|---|---|---|---|---|
| Open time | 30 | min | 20 | min | 15 | min | 10 | min | 5 | min | 4 | min | 2 | min |
| Time until | 50 | min | 45 | min | 30 | min | 20 | min | 12 | min | 10 | min | 5 | min |
| handling | | | | | | | | | | | | | | |
| strength: | | | | | | | | | | | | | | |
| Quasi-static | 18.7 | MPa | 15.3 | MPa | 15.5 | MPa | 17.1 | MPa | 18.0 | MPa | 14.0 | MPa | 13.1 | MPa |
| tensile shear | | | | | | | | | | | | | | |
| strength | | | | | | | | | | | | | | |

The results in table 1 and 2 show that the composition of the epoxy resins determines the open time. In formulations without cyclo-aliphatic epoxy resin (B1) the open time is 30 minutes. If the share of the cyclo-aliphatic resin Uvacure 1534 is increased, the open time reduces until it only amounts to 2 minutes any longer when the share is 2%. Times until handling strength are slightly longer accordingly. As a general rule, however, a large share of aromatic epoxy resins helps keeping the open time long. It has turned out that a large share of aromatic epoxy resin in the epoxy equivalent is advantageous, preferably a share of higher than 60%, in order to achieve a long open time.

As derives from the table, in B1 to B7 a structural bond is achieved (value higher than 6 MPa). It is not necessary to irradiate the already joined substrates the whole time. In fact, it is sufficient to irradiate the adhesive surface for a few seconds prior to joining. Afterwards, the adhesive film can still be joined. It is still adhesive and wets the second substrate to a sufficient extent. The joining also does not have to occur within seconds. The formulation can be adjusted such that an open time in a range of minutes is feasible. Joining takes place after the open time and without additional irradiation or heating a structural adhesive bond is obtained. By way of this open time it is possible to join substrates with the adhesive film regardless of their permeability for UV light.

b) Content of Epoxy-Enhanced Polyether Compound and Polyol Compound

Examples B8 to B11 show the significance of the epoxy-enhanced polyether compound in the formulation. D.E.R. 736 P was used as epoxy-enhanced polyether compound.

TABLE 3
Formulations B8 to B11

| | B8 | B9 | B10 | B11 |
|---|---|---|---|---|
| Desmomelt 530 | 11% | 11% | 11% | 11% |
| Araldite GT 7072 | 45% | 45% | 45% | 45% |
| D.E.R. 331 | 0% | 0% | 36% | 45% |
| D.E.R. 736 P | 42% | 36% | 0% | 0% |
| PEG 400 | 0% | 6.0% | 6.0% | 0% |
| Chivacure 1176 | 2% | 2% | 2% | 2% |
| Aₐᵣₒₘ | 78% | 81% | 100% | 100% |
| A_{cyc} | 0% | 0% | 0% | 0% |
| Aₑₜₕₑᵣ | 22% | 19% | 0% | 0% |

TABLE 4
Measurement results B8 to B11

| | B8 | B9 | B10 | B11 |
|---|---|---|---|---|
| Open time | 35 min | 35 min | 10 min | <10 seconds |
| Quasi-static tensile | 16.5 MPa | 14.1 MPa | 4.2 MPa | 1.9 MPa |
| shear strength | | | | |

Due to the D.E.R. 736, longer open times can be achieved, with or without polyethylene glycol. In the absence of D.E.R. 736, the polyol may extend the open time, but overall, the times are shorter and no structural adhesion strength is achieved (in B11). In this respect, the epoxy-enhanced polyether compound is advantageous for the properties of the adhesive tape.

Apart from the D.E.R. P, also other epoxy-enhanced polyether compounds are capable of fulfilling the same task, such as Araldite DY 3601 (company: Huntsman) and Heloxy Modifier WF (company: Hexion).

c) Polyol Content

In examples B12 to B19 the polyol share (here: PEG 400) varies whilst the median cyclo-aliphatic resin share remains constant and D.E.R 736 P only accounts for 12% in the formulation.

TABLE 5
Formulations B12 to B19

| | B12 | B13 | B14 | B15 | B16 | B17 | B18 | B19 |
|---|---|---|---|---|---|---|---|---|
| Desmomelt 530 | 11% | 11% | 11% | 11% | 11% | 11% | 11% | 11% |
| Araldite | 38% | 38% | 38% | 38% | 38% | 38% | 38% | 38% |
| GT 7072 | | | | | | | | |
| D.E.R. 736 P | 12% | 12% | 12% | 12% | 12% | 12% | 12% | 12% |
| D.E.R. 331 | 22% | 20% | 18% | 16% | 15% | 14% | 12% | 7% |
| Uvacure 1534 | 15% | 15% | 15% | 15% | 15% | 15% | 15% | 15% |
| PEG 400 | 0% | 2.0% | 4.0% | 6.0% | 7.0% | 8.0% | 10% | 15% |
| Chivacure 1176 | 2% | 2% | 2% | 2% | 2% | 2% | 2% | 2% |
| Aₐᵣₒₘ | 84% | 83% | 83% | 83% | 83% | 83% | 83% | 83% |
| A_{cyc} | 10% | 10% | 10% | 10% | 10% | 10% | 10% | 10% |
| Aₑₜₕₑᵣ | 6% | 7% | 7% | 7% | 7% | 7% | 7% | 7% |

TABLE 6
Measurement results B12 to B19

| | B12 | | B13 | | B14 | | B15 | | B16 | | B17 | | B18 | | B19 | |
|---|---|---|---|---|---|---|---|---|---|---|---|---|---|---|---|---|
| Open time | 30 | sec | 3 | min | 8 | min | 15 | min | 10 | min | 20 | min | 25 | min | 45 | min |
| Quasi-static | 2.2 | MPa | 8.3 | MPa | 10.4 | MPa | 10.3 | MPa | 17.1 | MPa | 17.1 | MPa | 16.7 | MPa | 15.5 | MPa |
| tensile shear | | | | | | | | | | | | | | | | |
| strength | | | | | | | | | | | | | | | | |

It turns out that increasing the polyol compound share results in an increased open time. Reducing the polyol share to zero results in shorter open times. They are too short to still allow for the formation of a structural bond (see B12).

Examples B1 to B19 show that varying the shares of aromatic epoxy resin, cyclo-aliphatic epoxy resin, epoxy-enhanced polyether compound and polyol within the preferred limits allows for a variation of the open time between 10 seconds and 60 minutes.

d) Film Formers and UV Initiators

Polymers of ethylene vinyl acetate (EVA), polyamide (PA), polyurethane (PU), acrylate or a phenoxy resin can be used as film formers. Examples B20 to B24 show formulations with different film formers. The share of the epoxy-enhanced polyether compound is high at 33 to 35% so that also without polyol, sufficiently long open times (10 seconds to 60 minutes) and structural adhesive strength are generated.

TABLE 7

| | Formulations of examples B20 to B24 | | | | |
|---|---|---|---|---|---|
| | B20 | B21 | B22 | B23 | B24 |
| Film former | 13.6% | 11.4% | 13.6% | 20.5% | 27.8% |
| | Levamelt | Desmomelt | Phenoxy | Levamelt | Levamelt |
| | 900 | 530N | Resin | 900 | 456 |
| | | | PKHM-301 | | |
| Araldite GT 7072 | 48.1% | 52.6% | 48.1% | 41.2% | 37% |
| D.E.R. 736 | 35.2% | 33% | 35.2% | 35.2% | 32.2% |
| Chivacure 1176 | 3.1% | 3.1% | 3.1% | 3.1% | 3.0% |
| Epoxy equivalent in g/eq | 409 | 424 | 409 | 393 | 391 |
| Aₐᵣₒₘ | 82% | 84% | 82% | 79% | 79% |
| A_{cyc} | 0% | 0% | 0% | 0% | 0% |
| Aₑₜₕₑᵣ | 18% | 16% | 18% | 21% | 21% |

TABLE 8
Measurement results B20 to B24

| | B20 | B21 | B22 | B23 | B24 |
|---|---|---|---|---|---|
| Open time | 30 minutes | 25 minutes | 30 minutes | 30 minutes | 20 minutes |
| Quasi-static tensile shear | 13.4 MPa | 14.9 MPa | 12.9 MPa | 11.2 MPa | 13.3 MPa |
| strength after 24 h | | | | | |

Different UV initiators were used, on different chemical bases, with and without photo-sensitizer. Here it turns out (see also tables 9 and 10) that the type of UV initiator has an impact on the open time. However, the preferred open times of 10 seconds to 60 seconds can be achieved with different types of UV initiators.

TABLE 9
Formulations of examples B25 to B29

| | B25 | B26 | B27 | B28 | B29 |
|---|---|---|---|---|---|
| Desmomelt 530 | 11.5% | 11.5% | 11.5% | 11.5% | 11.5% |
| Araldite GT | 53.0% | 53.1% | 53.1% | 53.1% | 53.1% |
| 7072 | | | | | |
| D.E.R. 736 P | 33.5% | 33.0% | 33.4% | 31.5% | 33.1% |
| UV initiator | 2.0% | 2.4% | 2.0% | 3.9% | 2% |
| | Chivacure | Chivacure | Omicat | Omicat | UV 387C + |
| | 1176 | 1190 | 432 | 550 | 0.3% |
| | | | | | Chivacure |
| | | | | | I-TX |
| Aₐᵣₒₘ | 84% | 84% | 84% | 85% | 84% |
| A_{cyc} | 0% | 0% | 0% | 0% | 0% |
| Aₑₜₕₑᵣ | 16% | 16% | 16% | 15% | 16% |

TABLE 10
Measurement results B25 to B29

| | B25 | B26 | B27 | B28 | B29 |
|---|---|---|---|---|---|
| Open time | 35 minutes | 30 minutes | 35 minutes | 60 minutes | 45 minutes |
| Quasi-static tensile shear | 13.6 MPa | 14.7 MPa | 11.8 MPa | 12.1 MPa | 17.5 MPa |
| strength after 24 h | | | | | |

As expected, also the amount of the UV initiator plays a role. As to be expected, when the initiator concentration increases, the open time decreases (see tables 11 and 12), whereas to a large extent structural adhesive strength is still achieved. In turn, long open times are achieved due to a large share of D.E.R. 736 P. Adjusting the open time so as to achieve shorter and thus faster curing formulations could still be implemented by adding cyclo-aliphatic epoxy resin in accordance with examples B1 to B7.

TABLE 11
Formulations of examples B22 to B26

| | B22 | B23 | B24 | B25 | B26 |
|---|---|---|---|---|---|
| Desmomelt 530 | 11.6% | 11.5% | 11.5% | 11.4% | 11.2% |
| Araldite GT 7072 | 53.7% | 53.3% | 53.0% | 52.5% | 51.8% |
| D.E.R. 736 P | 33.6% | 33.4% | 33.2% | 33.0% | 32.5% |
| Chivacure 1176 | 1.2% | 1.7% | 2.3% | 3.1% | 4.5% |

TABLE 12
Measurement results B22 to B26

| | B22 | B23 | B24 | B25 | B26 |
|---|---|---|---|---|---|
| Open time | 60 minutes | 45 minutes | 35 minutes | 25 minutes | 15 minutes |
| Quasi-static tensile shear | 13.9 MPa | 13.8 MPa | 13.6 MPa | 14.9 MPa | 15.4 MPa |
| strength after 24 h | | | | | |

e) UV Dosage

The open time can also be adjusted by regulating the UV dosage. A formulation (B27, consisting in 11.5% Desmomelt 530, 53.1% Araldite GT 7072, 16.1% D.E.R. 736 P, 17.1% Uvacure 1534, and 2.3% Chivacure 1176) is irradiated with different UV dosages (see table 13).

TABLE 13
Measurement results B27

| | | | | | | |
|---|---|---|---|---|---|---|
| UV dosage (UVC lamp) in | 270 | 197 | 125 | 93 | 76 | 47 |
| mJ/cm² | | | | | | |
| Open time in min | 0.5 | 1 | 1.5 | 3 | 5 | 10 |

f) Shelf Life

The shelf life of the adhesive tapes (prior to joining) is determined based on a sample according to example 22, which is packed light-tight in an aluminium bag. It is stored at room temperature. Also after 6 months of storage, sufficient open time and structural adhesive strength have been maintained.

TABLE 14
Measurement results storage of B22

| | Storage time | | |
|---|---|---|---|
| | Fresh | 2 months | 6 months |
| Open time | 60 minutes | 60 minutes | 50 minutes |
| Quasi-static tensile | 13.9 MPa | 13.8 MPa | 12.0 MPa |
| shear strength after 24 h | | | |

1. An adhesive film adapted to be wound and stamped, the adhesive film including an epoxy-based adhesive compound that can be activated by UV radiation, wherein the adhesive compound comprises:
a) 2-40 wt % of film former,
b) 10-70 wt % of aromatic epoxy resins,
c) cyclo-aliphatic epoxy resins, the cyclo-aliphatic epoxy resins not exceeding 33 wt %,
d) 0.3-7 wt % of cationic initiators,
e) 0-50 wt % of epoxy-enhanced polyether compounds, and
f) 0-20 wt % of polyol, the proportions adding up to 100%,
and the adhesive compound has an open time of 10 seconds to 60 minutes after the UV activation, during which open time the film has a pressure-sensitive adhesive characteristic.

2. The adhesive film of claim 1, wherein the adhesive film has a time until handling strength that does not exceed triple the open time.

3. The adhesive film of claim 1, wherein a share of an epoxy equivalent of the epoxy-enhanced polyether compounds in the epoxy equivalent of all the epoxy resins is between 0 and 40%.

4. The adhesive film of claim 1, wherein a share of an epoxy equivalent of the cyclo-aliphatic epoxy resins in the epoxy equivalent of all epoxy resins is between 0 and 33%.

5. The adhesive film of claim 1, wherein a share of an epoxy equivalent of the aromatic epoxy resins in the epoxy equivalent of all epoxy resins is above 60%.

6. The adhesive film of claim 1, wherein a film former comprises polymers of ethylene vinyl acetate (EVA), polyamide (PA), polyurethane (PU), acrylate or a phenoxy resin.

7. The adhesive film of claim 1, wherein the cationic initiator includes a cross-link initiating cationic initiators selected from arvlsulfonium salts, iodonium salts, thioxanthenium salts, and triarylsulfonium salts.

8. The adhesive film of claim 1, wherein the cationic initiator is activated by UV light.

9. The adhesive film of claim 1, wherein the film is adapted for structural bonding of metals, glass, ceramics, GFRP, CFRP, and high-energy surfaces.

10. The adhesive of claim 1, wherein the adhesive film has an adhesive strength of from about 6 MPA to about 20 MPA.

11. The adhesive film of claim 8, wherein the cationic initiator is activated by UVA light or UVC light
